(19) United States
(12) Patent Application Publication
(10) Pub. No.: US 2015/0231589 A1
(43) Pub. Date: Aug. 20, 2015

(54) MICROCAPSULES

(71) Applicant: Rohm and Haas Company, Philadelphia, PA (US)

(72) Inventors: Selvanathan Arumugam, Blue Bell, PA (US); Andrew Hughes, Richboro, PA (US); Ralph C. Even, Blue Bell, PA (US)

(21) Appl. No.: 14/624,404

(22) Filed: Feb. 17, 2015

Related U.S. Application Data
(60) Provisional application No. 61/941,127, filed on Feb. 18, 2014.

(51) Int. Cl. B01J 13/20

(52) U.S. Cl. CPC B01J 13/20

(57) ABSTRACT

A process for adjusting the wettability property of a plurality of on-demand activation-type microcapsules of a core and shell structure including the steps of: (a) providing a plurality of microcapsules of a core and shell structure, wherein the shell includes a polymeric matrix containing a certain amount of unreacted functionalizable reactive electrophiles covalently bonded to the surface of the wall of the shell of the microcapsules; and (b) contacting the plurality of microcapsules of step (a) with a certain amount of nucleophiles; wherein the nucleophiles are adapted to react with the electrophiles; and wherein the nucleophiles are adapted to modify the wettability property of the microcapsules' shell structure to a predetermined degree of hydrophilicity or solvent compatibility.

### CROSS-REFERENCE TO RELATED APPLICATIONS

The present application claims priority to U.S. Provisional Patent Application No. 61/941,127 filed on Feb. 18, 2014, the content of which is incorporated herein by references in its entirety.

### FIELD

The present application generally relates to capsules or microcapsules having a core and shell structure. More particularly, but not exclusively, the application relates to capsules or microcapsules where the shell wall of the microcapsules is solvent-compatible with various solvents. The subject application further relates to a method for preparing microcapsules.

### BACKGROUND

Encapsulation methods used to produce microcapsules are known in the art. One approach to encapsulation methods, such as for example, an inverse Pickering emulsion interfacial polymerization process, includes the use of a hydrophobically-modified clay nanoplatelet as an emulsifier to generate a stable Pickering emulsion from an immiscible two-phase liquid mixture. As an illustration, the two-phase liquid mixture can be, for example, an amine/water phase and a xylene phase. In the encapsulation process, polyisocyanates can be introduced into the process by dissolving the polyisocyanates in the xylene phase, and the introduction of the polyisocyanates initiates an in-situ interfacial polymerization which fabricates a layer of condensed polyurea-type shell wall around the polar core material (e.g., the amine/water phase), thus encapsulating the polar core material to form microcapsules.

Previously, the inverse Pickering emulsion interfacial polymerization method has been used to encapsulate polar materials such as water soluble actives in a water-in-oil (W/O) emulsion. For example, International Patent Publication No. WO 2012/166884 A2 discloses a method for preparing polyurea (PU) microcapsules using an inverse Pickering emulsion interfacial polymerization method for the micro-encapsulation of water soluble actives (e.g., aliphatic amine curing agents) from inverse emulsions.

In one example, International Patent Publication No. WO 2012/166884 A2 discloses a nano-particle inorganic clay modified with a hydrophobic quaternary amine (e.g., Laponite Cloisite 20A commercially available from Southern Clay Products) to stabilize droplets of aqueous amine. The aqueous droplets comprise an amine active dissolved in water (e.g., at 50% w/w). The modified nano-particle inorganic clay is used to stabilize the aqueous droplets in a non-polar continuous phase to form an inverse or W/O emulsion. An isocyanate is then added to the W/O emulsion to form a microcapsule wall or shell templated by the droplets of aqueous amine.

### SUMMARY

The present application relates to microcapsules having a core and shell structure. The shell structure includes a shell wall which is sufficiently modified to make the shell, and in turn the microcapsule, compatible with various solvents and at various degrees of compatibility.

In one embodiment, a process is directed to adjusting a wettability property (and therefore, the solvent-compatibility) of a plurality of on-demand activation-type microcapsules of a core and shell structure such that the shell wall, and in turn, the plurality of on-demand activation-type microcapsules, can be hydrophobic, hydrophilic, or somewhere in between hydrophilic and hydrophobic. For example, in one form, the process includes the steps of:

(a) providing a plurality of microcapsules of a core and shell structure, the shell including a polymeric matrix containing a certain amount of unreacted functionalizable reactive electrophiles covalently bonded to an external surface of the wall of the shell of the microcapsules; and

(b) contacting the plurality of microcapsules of step (a) with a certain amount of nucleophiles adapted to react with the electrophiles, the nucleophiles being adapted to modify the wettability property of the microcapsules to a predetermined degree of hydrophilicity or solvent compatibility anywhere in the range of from 100 percent (%) hydrophobicity to 100% hydrophilicity.

In one aspect, the process disclosed herein for modifying the wall of the shell of a microcapsule, i.e., functionalizing the functionalizable groups present on the surface of the shell wall, imparts a solvent compatibility characteristic to the microcapsule wall to form a microcapsule that is compatible with an otherwise non-compatible solvent. Accordingly, the microcapsules made by the process disclosed herein having a core and shell structure can be used in applications requiring that the shell wall of the microcapsules be compatible with certain solvents used in such applications.

Further aspects, embodiments, forms, features, benefits, objects and advantages shall become apparent from the detailed description provided herewith.

### BRIEF DESCRIPTION OF THE DRAWINGS

FIG. 1 is a schematic representation of a microcapsule with a functionalizable isocyanate group that can be functionalized and made solvent-compatible via a process described herein.

FIG. 2 is a series of optical microscope photographs of various polyurea microcapsules modified with different amines of varying hydrophobicity as illustrated by a directional arrow next to the photographs indicating the degree of hydrophobicity.

### DETAILED DESCRIPTION

For purposes of promoting an understanding of the invention, reference will now be made to the following embodiments and specific language will be used to describe the same. It will nevertheless be understood that no limitation of the scope of the invention is thereby intended, such alterations and further modifications in the described subject matter, and such further applications of the principles of the invention as described herein being contemplated as would normally occur to one skilled in the art to which the invention relates.

The examples given in the definitions are generally non-exhaustive and must not be construed as limiting the invention disclosed in this document.

“Solvent-compatible” or “solvent compatibility” as used herein, with reference to a microcapsule, means that the shell of the microcapsule via functional groups in the shell makes the microcapsule dispersible in a solvent.

“Templated” as used herein, with reference to microcapsules, means microcapsules are similar in size and number to the droplets of the emulsion that preceded the formation of the final microcapsules.

“Wettability” as used herein means the extent (or degree) that a surface (e.g., a microcapsule wall) can be chemically compatible with a solvent or liquid medium or a droplet of the liquid.

“Tunability” as used herein, with reference to a property, means the extent (or degree) that a property can be altered along a gradient to achieve a certain condition. For example, a surface's wettability may be tunable if the surface, when functionalized with a given amine, exhibits a lower contact angle than a surface that is unfunctionalized, or that is improperly functionalized.

“Functionalized” as used herein means reacted further with molecules containing a nucleophile and some other functionally desirable characteristic.

“Hydrophobicity” as used herein means tending to prefer to partition into the non-water phase when presented with a biphasic system consisting of water and a less polar phase.

“Quenching” as used herein means reaction of all residual isocyanate in the system.

In one embodiment, a process for producing microcapsules includes contacting a plurality of core-shell microcapsules with various nucleophile compounds to quench the microcapsules having a polymeric shell with electrophiles, and thereby producing microcapsules having a solvent-compatible shell.

Generally, one non-limiting process for producing microcapsules includes the following steps:

(a) providing a plurality of microcapsules of a core and shell structure, the shell including a polymeric matrix containing a certain amount of unreacted functionalizable reactive electrophiles covalently bonded to the surface of the wall of the shell of the microcapsules; and

(b) contacting the plurality of microcapsules of step (a) with a certain amount of nucleophiles adapted to react with the electrophiles, the nucleophiles being adapted to modify the wettability property of the microcapsules to a predetermined degree of hydrophilicity or solvent compatibility anywhere in the range of from 100% hydrophobicity to 100% hydrophilicity.

Another embodiment is directed to a plurality of microcapsules of a core and shell structure. The shell includes a polymeric matrix containing a certain amount of unreacted functionalizable reactive electrophiles covalently bonded to the surface of the wall of the shell of the microcapsules and can be prepared by interfacial polymerization, in-situ polymerization, or precipitation of the polymer from the polar or nonpolar phase and electrostatic deposition, such as by coacervation or layer-by layer deposition, just to provide a few non-limiting examples. Other processes which may be used in forming the microcapsules of step (a) can include the processes described in International Patent Publication NO. WO 2012/166884A2 and in U.S. Provisional Patent Application Ser. No. 61/941,066, both of which are incorporated herein by reference in their entireties.

The microcapsules formed from any of the above described processes include a core and shell structure (“core-shell structure”), where a core of active polar material (e.g., amines) is encapsulated by a shell. The shell includes a shell wall containing unreacted, functionalizable, reactive groups or electrophiles that can be modified by contacting the microcapsules with various nucleophiles.

For example, one method for preparing microcapsules may utilize an inverse emulsion polymerization technique using functional compounds (e.g., amines) such that the walls of the shell are constructed of a polymeric matrix containing functionalizable groups that can be further modified to form a shell wall that is compatible with various solvents.

As one illustrative embodiment of the above inverse emulsion polymerization method for producing microcapsules, the following steps can be carried out:

(i) contacting a non-polar liquid with a highly polar liquid adapted for forming an interface of an emulsion or suspension of the highly polar liquid in the nonpolar liquid;

(ii) emulsifying the contacted liquids to form an emulsion or suspension of the highly polar liquid in the non-polar liquid such that discrete droplets of the highly polar liquid are formed in the non-polar liquid; and

(ii) forming the polymer matrix by introducing a shell-forming compound into the emulsion or suspension such that the shell-forming compound reacts with a shell-forming compound present in the core to form a polymeric shell about the droplets of highly polar liquid to form microcapsules comprising a shell and core structure.

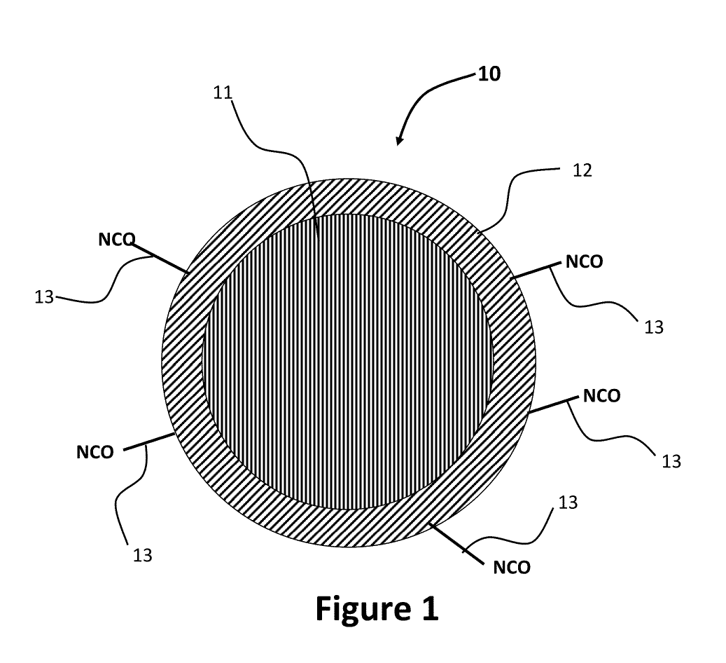

One embodiment of the microcapsules resulting from the above inverse emulsion polymerization method is shown in FIG. 1. With reference to FIG. 1, there is shown a microcapsule, indicated generally by reference numeral 10, comprising a core 11 of an active material and a shell 12 of a polymeric material (e.g., polyurea) encapsulating the core 11. The polymer shell 12 also includes unreacted groups 13 (e.g., isocyanate groups) that remain on the microcapsule periphery after the microcapsule is produced. These remaining groups 13 can be functionalized covalently with nucleophilic molecules (e.g., amines) that alter the wettability of the outer wall of the microcapsules after the microcapsules undergo the encapsulation process.

In one embodiment, inorganic particles (not shown) may be incorporated in polymeric shell 12. The particles can be completely embedded (encapsulated) in the body of shell 12. In other embodiments (not shown), the particles can be partially encased in the polymer shell 12; that is, the particles can protrude from the body of the shell through the top surface of the shell, the particles can protrude from the body of the shell through the bottom surface of the shell into the core 11, or the particles can protrude from the body of the shell in both manners.

After the plurality of core-shell microcapsules are produced in step (a), i.e., after the microencapsulation process for forming the microcapsules, the polymeric shell of the microcapsules can be contacted with various nucleophile compounds to quench the microcapsules and thereby produce microcapsules having a solvent-compatible shell. The solvent compatibility of the shell wall of the microcapsule can be adjusted or tuned to provide microcapsules with an appropriate/desired dispersibility in an aqueous continuous phase for a specific end use application. The “tunability” of the solvent compatibility feature of the microcapsule can be performed by varying the types of functional compounds used in the modification process after forming the core shell structure of the microcapsules.

For example, the shell wall of the microcapsules can be modified to form a solvent-compatible wall such that the wettability of the microcapsules can be tuned to be completely hydrophobic, completely hydrophilic or varying degrees of compatibility between these two extremes.

While not wanting to be bound to any particular theory, it is theorized that during the encapsulation process, partial reaction of polymerizable comonomers at the microcapsule periphery results in unreacted functional groups (electrophiles) on the outer wall of the microcapsules following encapsulation. The covalently bound functional groups serve as a “functional handle”, which can be reacted with various nucleophiles such as amines of varying hydrophobicity. This post-synthetic modification of the microcapsules tunes the wettability of the microcapsules to be hydrophobic, hydrophilic, or somewhere in between completely hydrophobic and completely hydrophilic depending on the types of nucleophiles used.

In one embodiment, a plurality of on-demand activation-type microcapsules is provided where each of the microcapsules includes a shell and core structure. The shell of the microcapsules includes a polymer matrix adapted to provide the microcapsules with a solvent-compatible characteristic, and the core of the microcapsules includes an active material and/or the highly polar liquid.

As one illustrative and non-limiting example of the above method, polyurea (PU) microcapsules containing water-soluble actives can be prepared and the microcapsules' outer wall can be functionalized to tailor the microcapsules' compatibility in different solvent systems, for example, using the following steps:

Step (a): providing a plurality of microcapsules of a core and shell structure by:

(i) contacting an aqueous solution of the active compound, polyethyleneimine (PEI), in xylene stabilized by hydrophobically modified clay particles;

(ii) preparing an inverse emulsion of the aqueous solution of the active compound, polyethyleneimine (PEI), in xylene stabilized by hydrophobically modified clay particles;

(iii) adding hydrophobic polyisocyanate (PMDI) to the above stable emulsion of step (b) in a sufficient amount to effect interfacial polymerization under vigorous stirring. After polymerization and encapsulation, the resultant outer shell of the microcapsules is formed such that the outer shell of the PU microcapsules is left with free isocyanate groups following encapsulation.

Step (b): contacting or quenching the microcapsules formed in step (a) above with an amine compound adapted to effect hydrophobicity or hydrophilicity or something in between to the outer shell of the microcapsules, thereby forming microcapsules having a solvent-compatible shell which includes a polymer matrix adapted to provide solvent-compatibility to the microcapsules, and a core which includes an active material and/or the highly polar liquid.

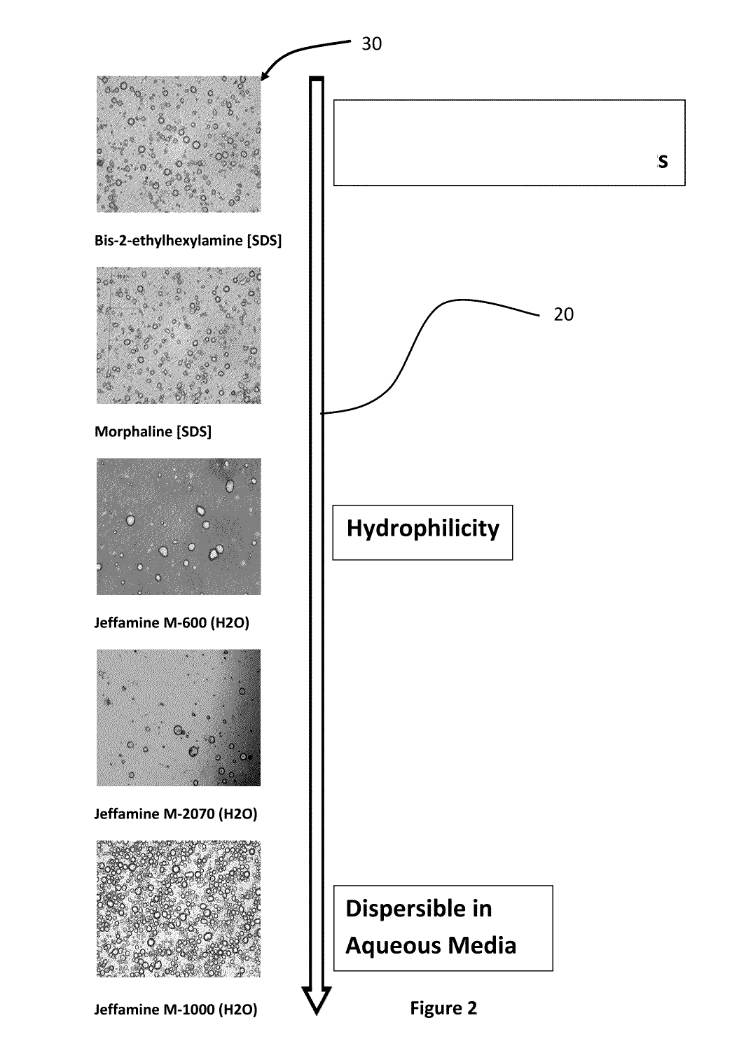

In the above embodiment, although PEI is used in excess during the microcapsule synthesis, the outer shell of the PU microcapsules is still left with free isocyanate groups following encapsulation. While not being bound to any particular theory, it is theorized that the remaining free isocyanate groups on the shell can be attributed to the barrier properties of the shell which restricts the diffusion of PEI and the PMDI comonomers through the shell so that the reaction between the 2 types of reactants slows dramatically. Some fraction of these multifunctional reactants will have reacted only partially when the process becomes very slow. The unreacted groups are the pendant isocyanates on the outside of the shell. It is anticipated that there may be analogous pendant amines on the inside of the shell. The resultant covalently bound unreacted isocyanate groups can be then be used as a functional handle to tune the compatibility of microcapsules in different solvents (See FIG. 2). For example, to obtain compatibility with hydrophobic solvents, the above quenching step can be carried out with a hydrophobic amine, and to obtain dispersibility in aqueous media, the above quenching step can be carried out with a hydrophilic amine.

The nonpolar liquids and the highly polar liquids are contacted and exposed to conditions such that an emulsion or suspension is prepared. The nonpolar liquids form the continuous phase and the highly polar liquids form the discontinuous phase. This is known as an inverse emulsion or suspension. The contacted liquids are subjected to one or more forms of agitation and/or shear to form the desired emulsion or suspension. Agitation and shear can be introduced through the use of impellers, ultrasonication, rotor-stator mixers and the like. For the industrial-scale production of emulsions or suspensions it is advisable to pass the mixture of nonpolar and highly polar liquids a number of times through a shear field located outside a reservoir/polymerization vessel until the desired droplet size has been reached. Exemplary apparatuses for generating a shear field are comminution machines which operate according to the rotor-stator principle, e.g., toothed ring dispersion machines, colloid mills and corundum disk mills and also high-pressure and ultrasound homogenizers. To regulate the droplet size, pumps and/or flow restrictors may be installed in the circuit around which the emulsion or suspension circulates.

Once a stable emulsion or suspension is formed the emulsion or suspension is subjected to polymerization conditions so as to form a polymer, such as install a polymer shell about the droplets of highly polar liquid. The conditions for polymerization are based on the choice of the polymer utilized. Any polymer system and associated process for preparation may be used which forms a polymer or deposits or forms the polymer as a shell about the droplets.

In one embodiment, the polymer is formed by interfacial polymerization. Typically in interfacial polymerization a polar (or hydrophilic) polymer forming component is located in the highly polar liquid phase and a non-polar (hydrophobic) polymer forming component is located in the non-polar liquid. Other components that impact or enhance the polymerization can be added to one or the other of the highly polar liquid or nonpolar liquid based on the relative polarity (hydrophilicity or hydrophobicity) of the ingredient, examples of such additives including catalysts, accelerators, initiators, fillers, crosslinking agents, chain extenders, gelling agents, and the like.

The polymerization is initiated by exposing the emulsion or suspension to conditions at which polymerization proceeds. Examples of this include adding ingredients, catalysts, initiators, accelerators, and the like; exposing the emulsion or suspension to temperatures at which polymerization proceeds at a reasonable rate; and the like. Such temperatures can be sub-ambient, ambient or super-ambient. In the embodiment where the polymerization proceeds at room temperature, such as for some reactions of polyisocyanates with compounds containing more than one active hydrogen containing groups, one of the ingredients is may be added after emulsification. In this embodiment the nonpolar (hydrophobic) component may be added after a stable emulsion or suspension is formed. This is because the continuous phase is nonpolar. Generally, interfacial polymerization stops when the polymerizable components can no longer contact each other. In one embodiment, this occurs when the polymer shell effectively forms a barrier around the droplets.

In a one embodiment, polymers prepared by interfacial polymerization include polyureas, polyurethanes and polyurea-urethanes, which are generally prepared from reacting a polyisocyanate compound and one or more compounds that react with the polyisocyanate compound.

The polyisocyanate compounds can be generally nonpolar and dissolve or disperse in the nonpolar solvent. The polyisocyanate compounds can be any polyisocyanate including more than one isocyanate group per molecule and, in one non-limiting form, include two or more isocyanate groups per molecule. In one form, the polyisocyanates have 4 or less isocyanate groups per molecule and in another form the polyisocyanates include 3 or less isocyanate groups per molecule. These numbers assume perfect reaction and ignore byproduct formation and are based on theoretical numbers of isocyanate groups that can be derived from the stoichiometry of the formation of such compounds. The polyisocyanates can be in the form of monomers or oligomers or prepolymers prepared from such monomers.

The polyisocyanates which may be used include, for example, any aliphatic, cycloaliphatic, araliphatic, heterocyclic or aromatic polyisocyanates, or mixtures thereof. In one form, the polyisocyanates used have an average isocyanate functionality of at least about 2.0 and an equivalent weight of at least about 80. In another form, the isocyanate functionality of the polyisocyanate is at least about 2.4 but no greater than about 4.0.

Higher functionality may also be used. In one form, the equivalent weight of the polyisocyanate is at least about 110 but no greater than about 300. Examples of polyisocyanates include those disclosed in U.S. Pat. No. 6,512,033 to Wu at column 3, line 3 to line 49, the contents of which are incorporated herein by reference in their entirety. More particular isocyanates are aromatic isocyanates, alicyclic isocyanates and derivatives thereof. In one aspect, the aromatic isocyanates have the isocyanate groups bonded directly to aromatic rings. Additional exemplary polyisocyanates include diphenylmethane diisocyanate and oligomeric or polymeric derivatives thereof, isophorone diisocyanate, tetramethylxylene diisocyanate, 1,6-hexamethylene diisocyanate and polymeric derivatives thereof, bis(4-isocyanatocylohexyl)methane, and trimethyl hexamethylene diisocyanate. In one particular but non-limiting form, the isocyanate is diphenylmethane diisocyanate and oligomeric or polymeric derivatives thereof. The amount of isocyanate containing compound used to prepare the prepolymer is that amount that gives the desired properties such as shell thickness, morphology, and shelf-life.

Generally, the concentration of the polyisocyanate compounds may be for example, from about 0.01 weight percent (wt %) to about 50 wt % in one embodiment, from about 0.1 wt % to about 10 wt % in another embodiment, and from about 1 wt % to about 5 wt % in still another embodiment. Wt % is relative to the weight of the polar discontinuous phase including the solvent (i.e., water) and all polar amine comonomers, actives and additives. The use of too much isocyanate is generally not detrimental because the reaction typically slows down considerably as soon as the initial polyurea shell is formed. Too little isocyanate may create an insufficiently dense shell.

After the polymer shells are formed on the droplets the microcapsules may be recovered by any known technique that does not substantially harm the microcapsules. Exemplary processes for recovery of the microcapsules include filtration of the microcapsules from the continuous phase, precipitation, spray drying, decantation, centrifugation, flash drying, freeze drying, evaporation, distillation and the like. The separation process is selected to effect a rapid and efficient separation, while minimizing mechanical damage to or disruption of the microcapsules, or exposure to chemistries that will attack the pendant isocyanate groups. The functionalization process step disclosed herein may be done after the recovery of the microcapsules, or in another form, this step may be performed in situ after addition of a judicious amount of isocyanate. A judicious amount of isocyanate is enough isocyanate to form a high quality shell, but which leaves only a small amount of residual isocyanate in the non-polar continuous phase. With very little isocyanate in the continuous phase, only enough functionalization reactant (i.e., monoamine) needs to be added to effect the full functionalization of the microcapsules.

In one embodiment, microcapsules include a shell and a core structure, and the shell of the microcapsule is modified to make the shell of the microcapsule solvent-compatible. A process for preparing microcapsules of this nature is also provided.

In one form, the core of the microcapsules disclosed herein includes one or more highly polar liquids such as one or more active materials. The core is in essence the droplets formed during the emulsification or suspension of the highly polar liquid in a nonpolar liquid. Upon formation of the core and shell structure of the microcapsules, the resultant core of the microcapsules includes an active material and the highly polar liquid.

The highly polar liquid may include, for example, liquids containing one or more active hydrogen atom containing groups, ethers, thioethers, sulphoxides, oxiranes, anhydrides, esters, and mixtures thereof. For example, the highly polar liquid may include water, amines, polyamines, alcohols, glycol ethers, amino alcohols, amides, dimethylsulfoxide (DMSO), and mixtures thereof. In one particular form, the highly polar liquid may be water, methanol, glycerol, ethylene glycol, dimethyl formamide dimethyl sulfoxide or mixtures thereof.

The active material of the core includes for example one or more amine compounds. Generally, the amine compound can be any amine having less than 10 carbon atoms in one embodiment, from 10 carbon atoms to about 100 carbon atoms in another embodiment, from 100 carbon atoms to about 1000 carbon atoms in still another embodiment, and greater than 1000 carbon atoms in yet another embodiment. Exemplary amine compounds include aliphatic amines, such as ethylenediamine, diethylenetriamine, triethylenetetramine, tetraethylenepentamine, 1,3-propylenediamine, and hexamethylenediamine; epoxy compound addition products from aliphatic polyamines, such as poly(1 to 5)alkylene(C₂ to C₆)polyamine-alkylene(C₂ to C₁₈) oxide addition products; aromatic polyamines, such as phenylenediamine, diaminonaphthalene, and xylylenediamine; alicyclic polyamines such as piperazine; heterocyclic diamines such as 3,9-bis-aminopropyl-2,4,8,10-tetraoxaspiro-[5.5]undecane; and mixtures thereof. Additional, particular but non-limiting examples include polyethyleneimine, tetraethylenepentamine, diethylenetriamine, 2-aminoethylethanolamine, ethylene diamine, triethylene tetramine, piperazine, aminoethyl piperazine, and mixtures thereof.

In another embodiment, the core of the microcapsules may contain an active material chosen from one or more of the following compounds: amines, alcohols, enzymes, DNA and other biopolymers, thiols, salts, ionomers, polymers, and mixtures thereof. In one form, the amine compound active material can function as a curing agent for a prepolymer or thermosetting resin, such as an epoxy resin, polyurethane, polyurea, aminoplast, thiourea and the like.

Generally, the concentration of the active material present in the core of the microcapsules may be for example, from 0 wt % to about 60 wt % in one embodiment, from about 10 wt % to about 40 wt % in another embodiment; and from about 20 wt % to about 33 wt % in still another embodiment, although other variations are contemplated. The wt % is relative to the weight of the polar discontinuous phase including the solvent (i.e., water) and all polar amine comonomers, actives and additives. In some forms, if the wt % of the active material is above 60 wt % the interfacial polymerization of the droplet surface is not efficient and encapsulation does not capture the bulk of the polar material.

One or more of several optional compounds may be included in the core of the microcapsules including for example a second known curing agent for epoxy resins that is sufficiently polar to be located in the highly polar liquid; a curing agent for one or more polyisocyanates; and other highly polar liquids.

Generally, the concentration of the optional components used in the core of the microcapsules may be for example, from 0 wt % to about 99 wt % in one embodiment, from about 20 wt % to about 80 wt % in another embodiment; and from about 30 wt % to about 50 wt % in still another embodiment, although other variations are possible.

In one form, the shell of the microcapsules disclosed herein includes a polymer matrix that can be formed at the interface of droplets of a highly polar liquid and nonpolar liquid after emulsification. In one aspect, the polymeric shell stabilizes the droplets of the highly polar liquid in the nonpolar liquid and imparts a desired barrier property to the transmission of active material through the shell. In addition, the polymeric shell, after emulsification and encapsulation, may include a polymeric shell that contains functionalized groups adapted to react with various amine compounds to form a polymer matrix which is compatible with various solvents.

The initial (or precursor) polymer matrix of the shell, prior to functionalization, can be formed via processes which include for example, interfacial polymerization, in-situ polymerization, or precipitation of the polymer from the nonpolar phase and electrostatic deposition, such as by coacervation or layer-by layer deposition. The initial polymer matrix shell of the microcapsules is adapted for providing functionalizable groups on the shell of the microcapsules. In one embodiment, the initial polymer can be formed via interfacial polymerization such as that described in International Patent Publication No. WO 2012/166884 A2.

The microcapsules disclosed herein may have an average size, largest diameter of, sufficient for the ultimate use of the microcapsules and which contains a sufficient amount of active material for the desired use. For example, the size of the microcapsules containing a curing agent active material can be from about 50 nanometers or greater, from about 500 nanometers or greater or from about 5,000 nanometers or greater. In one aspect, the size of the microcapsules is about 500,000 nanometers or less, 50,000 nanometers or less, or about 10,000 nanometers or less. In yet another embodiment, the size of the microcapsules can be from about 50 nanometers to about 500,000 nanometers.

The shell of the microcapsules disclosed herein is of sufficient thickness and modulus to provide the desired strength of the microcapsules and to provide the desired barrier properties to prevent the active material and/or highly polar liquid from leaking out through the shell. In one embodiment, the shell may have a thickness sufficient to prevent passage of the highly polar liquid or the active material through the shell. For example, the shell thickness can be 10 microns or less in one embodiment and 1 micron or less in another embodiment, although other variations are possible and contemplated.

The final polymer matrix shell of the microcapsules, after quenching as described herein, includes a sufficient amount of tethered groups on the shell that impart hydrophobicity or hydrophilicity to the microcapsules. The tethered groups on the shell essentially include a reaction product of (i) the functionalized groups formed after polymerization of the shell and (ii) the various nucleophile compounds described above.

One non-limiting embodiment includes preparing polyurea (PU) microcapsules such that during the encapsulation process some isocyanate comonomers undergo only partial reaction (i.e., not all isocyanate functional groups are converted to ureas or urethanes during the shell forming reaction) at the microcapsule periphery which results in unreacted isocyanate groups on the outer wall of the PU microcapsules after the encapsulation process. Then, the unreacted isocyanate groups of the PU microcapsules can be functionalized (i.e., reacted further with molecules containing a nucleophile and some other functionally desirable characteristic) with a polyether (for example, Jeffamine M-1000) which makes the microcapsules water-dispersible. Alternatively, the unreacted isocyanate groups of the PU microcapsules can be functionalized with an amine having a large hydrophobic group (for example, bis(2ethylhexyl) amine) which makes the microcapsules water-incompatible. The microcapsules will aggregate in water and will disperse only in hydrophobic environments like toluene.

The processes and microcapsules described herein are designed to improve the compatibility of a given microcapsule in a desired medium. Any amount of functionalizable group on the microcapsule's shell can result in a derivatized microcapsule that may improve the compatibility of such microcapsule over an under-derivatized microcapsule. An encapsulation method, that results in a greater quantity of functionalizable groups on the shell of a microcapsule, can also provide more derivitizable microcapsules and derivitization of such microcapsules will have a more pronounced effect.

In one embodiment, an excess nucleophile can be used and the unreacted nucleophile can be removed during the process of recovering the microcapsule (e.g., recovery can be carried out by filtration or decantation). The necessary amount of the nucleophile for full functionalization may be dependent upon the process used for encapsulation. For a particular encapsulation process, the minimum necessary amount of nucleophile for full conversion of electrophilic groups can be readily determined, for example, by titration of nucleophile into the system. Using for example the aforementioned titration method, the required amount of nucleophile for full conversion of electrophilic groups is reached at the point at which a detectible amount of the nucleophile is detected in the continuous phase. Such detection analysis may be carried out using gas chromatography (GC), nuclear magnetic resonance (NMR), or other methods known to those skilled in the art.

Exemplary solvents in which the shell of the microcapsules may be solvent-compatible include one or more of the following: aliphatic, cycloaliphatic and aromatic hydrocarbons; esters; oils; alcohols; ketones; and mixtures thereof. For example, the solvent compatible with the microcapsules may include solvents selected from the group consisting essentially of benzene, toluene, xylene, hexanes, cyclohexanes, decalin, ethyl acetate, acetonitrile, acrylate monomers, methacrylate monomers, mineral oil, water, methanol, acetone, acetic acid and mixtures thereof.

Optionally, the polymer shell of the microcapsules may contain particles. When the shell contains particles, the particles can be any particles that stabilize the droplets of the highly polar liquid in the polar liquid and which imparts the desired properties to the shell. In one embodiment, the particles are solid. The shape and aspect ratio of the particles can be any shape or aspect ratio that provides the desired properties to the shells, including platy, acicular (needle-like) or spherical particles.

The particles useful for the polymer shell of the microcapsules can be inorganic, organic or have both an organic and an inorganic component. Exemplary inorganic particles include metals; metal alloys; metal salts; metal oxides; metal sulfides; synthetic and naturally occurring minerals; clays and any of the other inorganic particles described in International Patent Publication No. WO 2012/166884 A2; and mixtures of one or more of the above particles.

The particles may include organic particles such as polymer particles of an appropriate organic material and size which improves the desired properties of the microcapsule. For example, the organic polymer particles can include crosslinked latex particles, and any of the organic polymers described in International Patent Publication No. WO 2012/166884 A2.

Alternatively, the particles may include inorganic particles modified with organic materials to improve the properties of the particle. In one embodiment, the particles include a mineral, for example a nanoclay, which is modified with an organic compound.

For example, such modified inorganic particles may include nanoclays modified on their surfaces with an onium compound such as particles commercially available from Southern Clay products under the trade names and designations of CLOISITE 20A, CLOISITE 30B, CLOISITE 10A and CLOISITE 93A nanoclays, and any of the modified particles described in International Patent Publication No. WO 2012/166884 A2.

Generally, the amount of the optional particles, when present, may be for example, from 0 wt % to about 25 wt % in one embodiment, from about 0.01 wt % to about 20 wt % in another embodiment; from about 0.1 wt % to about 10 wt % in still another embodiment; and from about 1 wt % to about 5 wt % in yet another embodiment, although other variations are contemplated

The microcapsules disclosed herein may contain any other optional materials that are present in the emulsion or dispersion during microcapsule formation which materials do not impact or deleteriously affect the active materials or the function of the microcapsules. For example, the other optional materials can include emulsifiers, surfactants, stabilizers and the like.

Generally, the concentration of the optional materials when used may be for example, from 0 wt % to about 25 wt % in one embodiment, from about 0.01 wt % to about 20 wt % in another embodiment; from about 0.1 wt % to about 10 wt % in still another embodiment; and from about 1 wt % to about 5 wt % in yet another embodiment. Wt % is relative to the weight of the polar discontinuous phase including the solvent (i.e., water) and all polar amine comonomers, actives and additives.

One property of the microcapsules disclosed herein is solvent-compatibility. For example, the solvent-compatibility of the microcapsules can be visually observed by the degree or tendency of the microcapsules to flocculate or aggregate in a given solvent. Less compatible microcapsules will aggregate more quickly and with a more pronounced separation of the solvent (generally at the top) and the microcapsules (generally at the bottom).

As one embodiment of a quantifiable comparative measure of aggregation, the dispersion of microparticles may be strained through a series of sieves having progressively smaller pore sizes. A poorly dispersed system will exhibit a higher proportion of the system's microcapsule content retained in a larger pore sieve, while a better dispersed system will allow the system's microcapsules to filter farther down a stack of sieves having progressively smaller pore sizes. In the above test the microcapsules are synthesized in an identical manner and the systems being compared differ only in the type of nucleophile with which the microcapsules are washed, or in the nature of the continuous phase in which the microcapsules are dispersed.

As an illustrative example, and not to be limited thereby, microcapsules that have been functionalized with bis(2-ethylhexyl)amine are compatible with nonpolar solvents such as toluene. The bulk of microcapsule mass of a dispersion of the above microcapsules in toluene will be captured in a smaller pore sized sieve than a dispersion in toluene of the same microcapsules that have not been functionalized with bis(2-ethylhexyl)amine or other hydrophobic nucleophile. Further, the bulk of microcapsule mass of a dispersion of the above bis(2-ethylhexyl)amine functionalized microcapsules in toluene will be captured in a smaller pore sized sieve than a dispersion of the same microcapsules in water. The above same microcapsules will aggregate in water; and therefore a greater bulk of microcapsule mass will be captured in a larger pore sized sieve.

The microcapsules disclosed herein can be used in any application where conventional microcapsules are used. For example, in one embodiment, the microcapsules disclosed herein may be used as a component in a curable composition, which in turn, can be used to manufacture a cured thermoset product for various end uses such as coatings, adhesives, and composites.

In addition, the microcapsules disclosed herein can be used in applications where the solvent compatibility of the microcapsules was previously an issue, and now the microcapsules' solvent compatibility can be adjusted to allow the microcapsules to be used in a particular end use.

For example, in one embodiment, a curable epoxy resin composition can include (a) a plurality of microcapsules having a solvent-compatible shell described above; (b) a solvent compatible with the microcapsules; and (c) at least one epoxy monomer compound to form the curable composition.

In one aspect, the microcapsules disclosed herein enhance dispersion in a nonpolar reactive matrix such as for example an epoxy resin. Thus, the solvent useful for dispersing the microcapsules can be the epoxy monomer itself. The epoxy monomer can be, for example, commercially available epoxy resins such as DER™331 available from The Dow Chemical Company.

Other optional components, and their concentration, that can be added to the curable composition are well known those skilled in the art such as for example, various catalysts, inert fillers, and the like.

The above curable composition can be used to produce a cured epoxy resin composite. For example in one embodiment, the process for producing a cured epoxy resin composite can include the steps of:

(a) admixing (i) a plurality of the microcapsules having a solvent-compatible shell described above; (ii) a solvent compatible with the microcapsules; and (iii) at least one epoxy monomer compound to form the curable composition;

(b) applying an activation stimuli to the curable composition of (a) such that the shell of the microcapsules rupture and the active material from the core of the microcapsules contacts the epoxy monomer compound to form a reaction mixture; and

(c) heating the resultant reaction mixture of (b) at a temperature sufficient to cure the reaction mixture of (b) to form a cured epoxy resin composite.

By applying an activation stimuli to the microcapsules of the curable composition, at a desired or predetermined time period, the shell of the microcapsules rupture and the active material curing agent from the core of the microcapsules contacts the epoxy monomer compound to form a curable reaction mixture. The curing agent from the microcapsule uniformly diffuses throughout the epoxy resin network. The resultant reaction mixture can then be heated at a curing temperature sufficient to cure the reaction mixture to form a cured epoxy resin composite. The curing temperature can be from about 0° C. to about 250° C. in one embodiment and from about 10° C. to about 40° C. in another embodiment, although other variations are contemplated.

The activation stimuli for rupturing the shell of the microcapsules can be, for example, a shearing force. In one aspect, the microcapsules disclosed herein are sufficiently robust to withstand the shearing forces of formulation, shipping and handling, and the shearing force of activation may be any force that is above this threshold, which may differ according to the final application of the microcapsules. As an illustration, and not to be bound thereto, one example of a shearing force applied to rupture the microcapsules can be for example the shearing force of a 1 cm rotor stator homogenizer spinning at 1000 rpms for 1 minute when applied to an approximately 10 g sample of microcapsules in epoxy resin.

In another embodiment, microcapsules such as polyurea microcapsules made by inverse Pickering emulsion interfacial polymerization can be modified in accordance with the process disclosed herein for making polyurea encapsulated enzymes for laundry detergent applications. For example, an inverse Pickering emulsion interfacial polymerization to encapsulate enzymes in aqueous media can be used such as a process described in International Patent Publication No. WO 2012/166884 A2 or in U.S. Provisional Patent Application Ser. No. 61/941,066.

The above described polymerization process can be used to encapsulate laccase, and the encapsulated laccase can be used in a detergent formulation. The microcapsules with laccase (encapsulation of the enzyme)have the following properties: (1) the microcapsules exhibit an extended shelf-life; (2) the unencapsulated formulation components are protected from degradation; and (3) the encapsulated enzymes can be released from the microcapsule using shear force (e.g., ultrasonication) and the released enzyme retains its activity.

In one embodiment, an encapsulated enzyme within polyurea microcapsules is provided. The encapsulated enzyme can be isolated from other components (e.g., incompatible components such as other enzymes, anionic surfactants, nonionic surfactants, polymers, and builder systems, typical components of a detergent formulation) because the other components in the formulation can have a deleterious effect on the enzyme. For example, the encapsulation of enzymes within polyurea microcapsules isolates the active enzyme from interacting with surfactants and polymers and thereby extends the lifetimes of the active enzyme, surfactants and polymers. The extended lifetime can occur at room (about 25° C.) and elevated temperatures such as 40° C.

It has been demonstrated that the polyurea is not permeable to larger molecules and aggregates such as enzymes, polymers and surfactants while allowing smaller neutral molecules (e.g., H₂O) to shuttle in and out. Additionally, it has been observed that the colorant in a laundry detergent can be protected from bleaching when the colorant is in the presence of oxidizing enzymes, i.e., the encapsulation of oxidizing enzymes prevents the enzymes from bleaching the colorant and other active components, suggesting that charged molecules may have enhanced barrier for diffusion across polyurea shell. This is an indication that the enzyme can be well isolated from dye molecules present in a formulation. Then, the microcapsules can be triggered to release the active enzyme using shear force such as sonication and the like.

As an illustrative example, laccase can be encapsulated within polyurea microcapsules through inverse Pickering emulsion interfacial polymerization from a water-in-xylene emulsion. After the microcapsule formation, the excess xylene can be removed and the microcapsules can be repeatedly washed with isopropanol. The washed microcapsules can then be re-dispersed in a test detergent formulation. The stability of laccase can be determined through enzyme activity assay. This physical isolation of enzymes from a high concentration of surfactants and polymers extends the lifetime of the enzymes relative to a control. The preservation of colorant in a formulation can be quantified for example by absorption measurements at 583 nm using a UV-Visible spectrometer.

### EXAMPLES

The following examples and comparative examples further illustrate the present invention in detail but are not to be construed to limit the scope thereof.

Various terms and designations used in the following examples are explained herein below:

“SDS” stands for sodium dodecyl sulfate.

Jeffamine M-600, M2070 and M-1000 are monofunctional amine derivatives of poly(propyleneglycol) and poly(ethyleneglycol) in different chain lengths and relative ratios commercially available from Huntsman.

Tween 20 is a non-ionic surfactant commercially available from Sigma Aldrich.

### Example 1

The outer wall of PU microcapsules are functionalized to tailor the microcapsules compatibility in different solvent systems using the following general procedure:

The polyurea (PU) microcapsules containing water soluble actives are prepared for example in two steps. First, an inverse emulsion comprising aqueous solution of the active (300 mg, 6 g of 5% aqueous solution) and polyethyleneimine (PEI) (0.12 g) in xylene (25 g) stabilized by hydrophobically modified clay particles (0.03 g) is prepared using ultrasonication (50% Power, 4×5 seconds) at room temperature (RT, about 25° C.). To this stable emulsion, hydrophobic polyisocyanate (PMDI) (0.2 g in 5 g xylene) is added to effect interfacial polymerization under vigorous stirring (1500 rpm) at RT. PEI is used in excess (excess reactive amine to NCO) during the capsule synthesis but the outer shell of PU microcapsules are left with free isocyanate groups post encapsulation. The covalently bound unreacted isocyanate groups are used as a functional handle to tune the compatibility of microcapsules in different solvents.

For compatibility with hydrophobic solvents, the microcapsules are quenched with a hydrophobic amine. For miscibility in aqueous media, the microcapsules are quenched with a hydrophilic amine.

For example, PU microcapsules containing the enzyme laccase are quenched with amines of varying hydrophobicity, and the miscibility of the PU microcapsules in organic and aqueous media was checked using an optical microscope. Miscible, or compatible, systems disperse freely and can be transferred to a microscope slide with a pipette having an aperture of less than 5 millimeters. On the microscope the microcapsules are distributed and aggregation is minimal.

When the PU microcapsules are quenched with bis-2-ethylhexylamine, the microcapsules are compatible with xylene. However, the PU microcapsules aggregate in water and cannot be smoothly pipetted and observed by microscopy. The PU microcapsules quenched with bis-2-ethylhexylamine require the presence of an anionic surfactant such as SDS in the water to go in to the water.

When the PU microcapsules are quenched with a relatively less hydrophobic amine, such as morpholine, the miscibility of the PU microcapsules with xylene is reduced resulting in separation of microcapsules from the xylene phase. However, the PU microcapsules still require the presence of an anionic surfactant such as SDS in the water to make the PU microcapsules water dispersible.

Reacting the outer shell free isocyanates with relatively hydrophilic amines such as Jeffamine M-600, M2070 and M-1000 make the PU microcapsules more hydrophilic and immiscible in xylene. However, M-600 and M-2070 modified microcapsules still require the assistance of Tween 20 (a non-ionic surfactant) in order to be dispersed in aqueous media. PU microcapsules functionalized with M-1000, which contains a higher proportion of ethylene oxide relative to propylene oxide than M-600 and M-2070, are readily miscible with water without the assistance of any surfactants.

Optical microscope pictures of various PU microcapsules containing laccase quenched with various amines are presented in FIG. 2. The PU microcapsules modified with different amines of varying hydrophobicity can be illustrated by the directional arrow 20 next to the optical microscope pictures (generally indicated by numeral 30) indicating the degree of hydrophobicity moving from the most hydrophobic solvent to the most hydrophilic solvent in the direction of the arrow 20.

The above, examples, explanations and illustrations presented herein are intended to acquaint others skilled in the art with the present invention, its principles, and its practical application. Those skilled in the art may adapt and apply the present invention in its numerous forms, as may be best suited to the requirements of a particular use. Accordingly, the specific embodiments of the present invention as set forth above are not intended as being exhaustive or limiting of the present invention. The scope of the present invention should, therefore, be determined not with reference to the above description, but should instead be determined with reference to the appended claims, along with the full scope of equivalents to which such claims are entitled. The disclosures of all articles and references, including patent applications and publications, are incorporated herein by reference for all purposes. Other combinations are also possible as will be gleaned from the appended claims, which are also hereby incorporated by reference into this written description.

For example, the modification of microcapsule walls with functional amines to tailor the property of the microcapsules can include more than tuning solvent compatibility, i.e., the covalently bound isocyanate that remains unreacted on the outer wall of PU microcapsules can be functionalized to tune the solvent compatibility of the microcapsules; and on a broader scope, the modification chemistry disclosed herein can be expanded and applied beyond solvent compatibility tuning such as tethering other functionalities to the PU microcapsule wall for different applications. For example, various functional motifs such as fluorophores, binding ligands and the like may be tethered. The functional density of free isocyanate groups can also be manipulated by adjusting the reaction conditions. Similarly, the techniques outlined herein can be applicable generally to any microcapsules formed by inverse emulsion and interfacial polymerization. In addition, an appropriate functionalization chemistry can be based upon the nature of the continuous phase comonomer used in preparing the microcapsules. For example, in preparing PU microcapsules, other nucleophiles other than amines (e.g., alcohols) can also be useful to modify the pendant isocyanates.

What is claimed is:

1. A process for adjusting the wettability property of a plurality of on-demand activation-type microcapsules of a core and shell structure comprising the steps of:
(a) providing a plurality of microcapsules of a core and shell structure, wherein the shell comprises a polymeric matrix containing unreacted functionalizable reactive electrophiles covalently bonded to the surface of the wall of the shell of the microcapsules; and
(b) contacting the plurality of microcapsules of step (a) with nucleophiles adapted to react with the electrophiles and wherein the nucleophiles are adapted to modify the wettability property of the microcapsules to a predetermined degree of hydrophilicity or solvent compatibility anywhere in the range of from 100 percent hydrophobicity to 100 percent hydrophilicity.

2. The process of claim 1, wherein the shell wall of the plurality of on-demand activation-type microcapsules is adjusted to be hydrophobic.

3. The process of claim 1, wherein the shell wall of the plurality of on-demand activation-type microcapsules is adjusted to be hydrophilic.

4. The process of claim 1, wherein the shell wall of the plurality of on-demand activation-type microcapsules is adjusted to be in between hydrophilic and hydrophobic.

5. The process of claim 1, wherein the microcapsules of step (a) are produced by an inverse interfacial polymerization method.

6. The process of claim 1, wherein the electrophiles are selected from the group consisting of isocyanates, epoxides, acid chlorides, and mixtures thereof.

7. The process of claim 1, wherein the nucleophiles are selected from the group consisting of amines, alcohols, thiols, and mixtures thereof.

8. The process of claim 7, wherein the amine compound is selected from the group consisting of bis(2-ethylhexyl)amine, morpholine, monofunctional amine derivatives of poly(propyleneglycol), monofunctional amine derivatives of poly(ethyleneglycol) and mixtures thereof.

9. The process of claim 1, wherein the amount of unreacted functionalizable reactive electrophiles covalently bonded to the surface of the wall of the shell of the microcapsules is from about 0.001 mmol/g microcapsules to about 1 mmol/g microcapsules.

10. The process of claim 1, wherein the amount of nucleophiles adapted to react with the electrophiles is from about 0.001 mmol/g microcapsules to about 1 mmol/g microcapsules.

11. The process of claim 1, wherein the polymer matrix is selected from the group consisting of a polyurea, polyurethane, polyurea-urethane or a mixture thereof.

12. The process of claim 1, wherein the shell further comprises a plurality of particles in contact with the polymer matrix, and wherein the plurality of particles is a plurality of nanoclays.

13. The process of claim 1, wherein the microcapsules of step (a) are solvent-compatible with solvents selected from the group consisting of benzene, toluene, xylenes, hexanes, cyclohexane, decalin, ethyl acetate, acetonitrile, acrylate monomer, methacrylate monomers, mineral oil, water, methanol, acetone, acetic acid, and mixtures thereof.

14. The process of claim 1, wherein the core of the microcapsules contains an active selected from the group consisting of amines, alcohols, enzymes, DNA and other biopolymers, thiols, salts, ionomers, polymers, and mixtures thereof.

15. A plurality of on-demand activation-type microcapsules of a core and shell structure prepared by the process of claim 1.
